(19) United States
(12) Patent Application Publication
(10) Pub. No.: US 2018/0216781 A1
(43) Pub. Date: Aug. 2, 2018

(54) STRAPLESS BRACKET SYSTEM

(71) Applicant: Gregory Hall, Overland park, KS (US)

(72) Inventor: Gregory Hall, Overland park, KS (US)

(21) Appl. No.: 15/417,336

(22) Filed: Jan. 27, 2017

(51) Int. Cl. F16M 13/02; F16B 2/06; F16M 11/06

(52) U.S. Cl. CPC F16M 13/022; F16M 11/06; F16B 2/065

(57) ABSTRACT

Disclosed is a strapless bracket system. The strapless bracket system for securely holding at least one panel on a hood stand comprises of a strapless bracket adapted for pulling the at least one panel securely to a neoprene padded foot coupled with the strapless bracket, a bolt down bracket adapted for mounting and adjusting the at least one panel on the hood stand, an universal clamp adapted for enabling the strapless bracket and the bolt down bracket to be mounted on the hood stand, and a cap bracket mount adapted for enabling the strapless bracket and the bolt down bracket to be mounted on top of the hood stand.

### FIELD OF THE INVENTION

The present application generally relates to the field of brackets. Particularly, the application provides a strapless bracket system. More particularly, the application provides a strapless bracket system for securely holding down panels on a hood stand such as automotive doors, hoods, lift gates, trunks, and side mount panels by eliminating need for straps.

### BACKGROUND

Past decades have witnessed tremendous growth and development in automobile industry, due to increased demand of human mobility. The increased number of automotive vehicles and other means of mobility have certainly improved human life by several folds, in terms of covering long distances in shorter period of time with higher degree of comfort. However, at the same time it has also demonstrated severe consequences, such as higher number of accidents causing damages to automotive vehicles and other means of mobility. Automotive vehicular damages vary from complete collapse to minor dents on the vehicular body.

Prior art illustrates development of various tools, techniques, methods in response to the minor dents and associated problems, such as paint-less dent repair. While development of any such paint-less dent repair solutions, holding damaged parts of automotive vehicle is always considered as one of the critical focus area. Prior art literature illustrates a variety of solution for holding automotive parts such as doors, hoods, and alike, however, most of the solutions require such automotive parts to be held on hood stands with the help of straps. In addition, holding such automotive parts on hood stands with the help of straps may hamper the flexibility and relative movement of such automotive parts on hood stands while repairing.

In view of the above mentioned background, it is evident that, there is a need for a strapless bracket system, which could securely, holds down automotive doors, hoods, lift gates, trunks, and side mount panels by eliminating need for straps of any kind. There is a need for a strapless bracket system, which could provide flexibility and greater relative movement of such automotive parts on hood stands while repairing. A strapless bracket system is desired.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a strapless bracket system.

Another objective is to provide a strapless bracket system which could securely holds down at least one panel on a hood stand such as automotive doors, hoods, lift gates, trunks, and side mount panels by eliminating need for straps of any kind.

Another objective is to provide a strapless bracket system which could be adjusted to many different applications such as automotive and paint less dent repair industries.

In accordance with one embodiment of the present invention, a strapless bracket system (100) for securely holding at least one panel on a hood stand is provided. The strapless bracket system (100) for securely holding at least one panel on a hood stand comprises of a strapless bracket (102) adapted for pulling the at least one panel securely to a neoprene padded foot (104) coupled with the strapless bracket (102); a bolt down bracket (112) adapted for mounting and adjusting the at least one panel on the hood stand; an universal clamp (108) adapted for enabling the strapless bracket (102) and the bolt down bracket (112) to be mounted on the hood stand; and a cap bracket mount adapted for enabling the strapless bracket (102) and the bolt down bracket (112) to be mounted on top of the hood stand.

The above configuration is provided for a strapless bracket system for securely holding at least one panel on a hood stand but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 is a diagram illustrating perspective view of a strapless bracket system comprising a strapless bracket and an universal clamp, in accordance with one embodiment of the present invention;

FIG. 2 is a diagram illustrating upper view of a strapless bracket system comprising a strapless bracket and an universal clamp, in accordance with one embodiment of the present invention;

FIG. 3 is a diagram illustrating side view of a strapless bracket system comprising a strapless bracket and an universal clamp, in accordance with one embodiment of the present invention;

FIG. 4 is a diagram illustrating perspective view of a strapless bracket system comprising a bolt down bracket and an universal clamp, in accordance with one embodiment of the present invention;

FIG. 5 is a diagram illustrating upper view of a strapless bracket system comprising a bolt down bracket and an universal clamp, in accordance with one embodiment of the present invention;

FIG. 6 is a diagram illustrating side view of a strapless bracket system comprising a bolt down bracket and an universal clamp, in accordance with one embodiment of the present invention;

FIG. 7 is a diagram illustrating perspective view of a cinch, in accordance with one embodiment of the present invention; and

FIG. 8 is a diagram illustrating perspective view of a universal clamp, in accordance with one embodiment of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In accordance with one embodiment of the present invention, a strapless bracket system (100) for securely holding at least one panel on a hood stand is provided. The strapless bracket system (100) for securely holding at least one panel on a hood stand comprises of a strapless bracket (102) adapted for pulling the at least one panel securely to a neoprene padded foot (104) coupled with the strapless bracket (102); a bolt down bracket (112) adapted for mounting and adjusting the at least one panel on the hood stand; an universal clamp (108) adapted for enabling the strapless bracket (102) and the bolt down bracket (112) to be mounted on the hood stand; and a cap bracket mount adapted for enabling the strapless bracket (102) and the bolt down bracket (112) to be mounted on top of the hood stand.

In accordance with one embodiment of the present invention, the strapless bracket system (100) may be manufactured from a material selected from a group comprising but not limited to aluminum, stainless steel, and rubber. The at least one panel is selected from a group comprising but not limited to automotive doors, hoods, lift gates, trunks, and side mount panels.

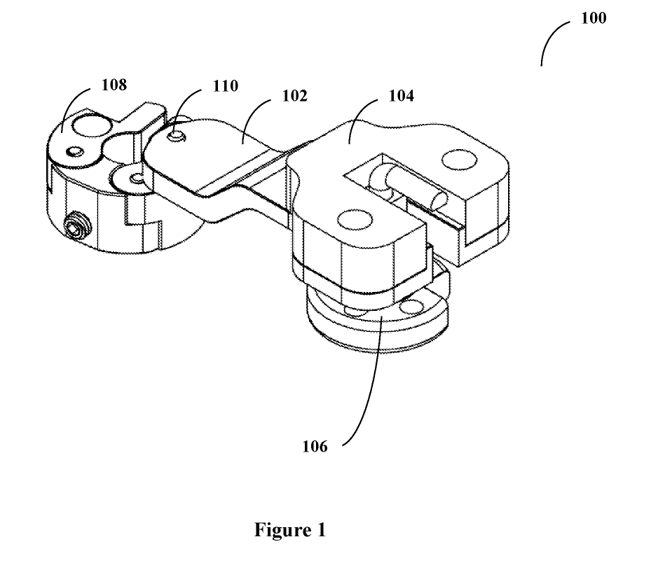

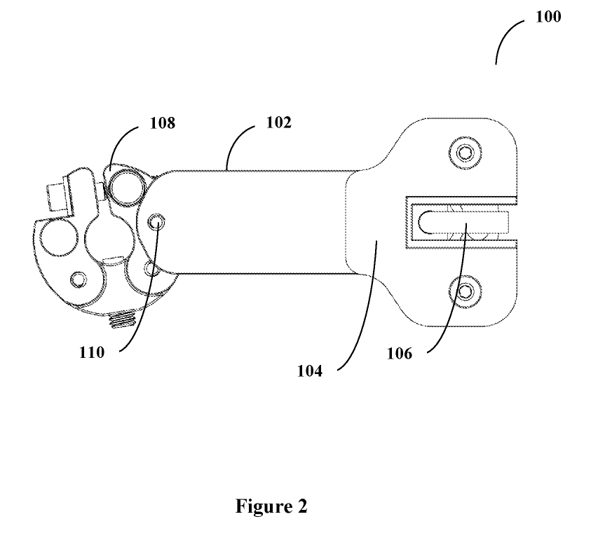

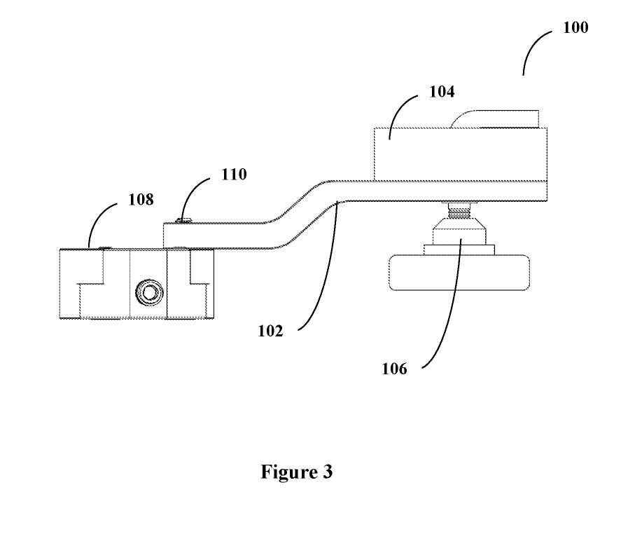

Referring to the FIG. 1; FIG. 2; and FIG. 3 are diagrams illustrating perspective; upper and side views correspondingly of a strapless bracket system comprising a strapless bracket and an universal clamp, in accordance with one embodiment of the present invention.

In accordance with one embodiment of the present invention, the strapless bracket system (100) for securely holding at least one panel on the hood stand is provided. The at least one panel may be selected from a group comprising but not limited to automotive doors, hoods, lift gates, trunks, and side mount panels. The strapless bracket system (100) may comprises of the strapless bracket (102) coupled with the universal clamp (100) using a quick release pin (110). The strapless bracket (102) may be adapted for pulling the at least one panel securely to the neoprene padded foot (104) coupled with the strapless bracket (102) with help of the cinch (106). The strapless bracket (102) may pull the at least one panel securely to the neoprene padded foot (104) coupled with the strapless bracket (102) with help of the cinch (106) using an opening of ¼″ or larger in the at least one panel. The universal clamp (100) may be adapted for enabling the strapless bracket (102) and the bolt down bracket (112) to be mounted on the hood stand, wherein the strapless bracket (102) is coupled with the universal clamp (100) using the quick release pin (110). The quick release pin (110) may allow for easy adjusting and movement of the strapless bracket (102) and the bolt down bracket (112), while removal and installation of the quick release pin (110) may be done a push of a button. The neoprene padded foot (104) may be extremely durable and helping strongly grip over the at least one panel securely, while protecting coat of the at least one panel. The strapless bracket (102) may be CNC machined from a solid block of aluminum.

In accordance with one embodiment of the present invention, the cinch (106) may further comprises of a L shape hook (120) for pulling the at least one panel securely to the neoprene padded foot (104) coupled with the strapless bracket (102). The cinch (106) may further comprises of a tension knob (122) for adjusting hold down pressure on the at least one panel. The tension knob (122) may be connected with the L shape hook (120) using a rectangular support (124). The tension knob (122) may be manufactured from aluminum and the L shape hook (120) may be manufactured from stainless steel.

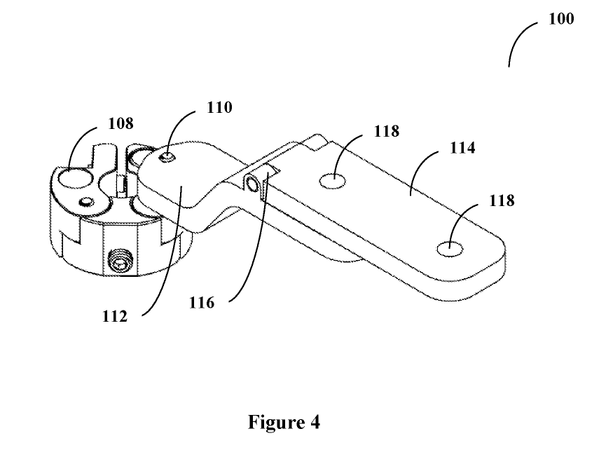

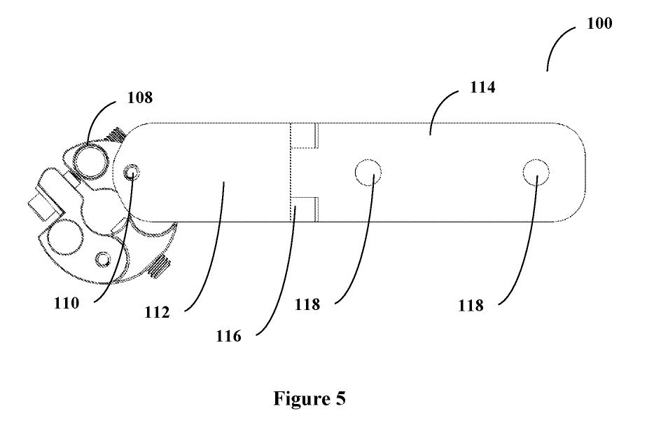

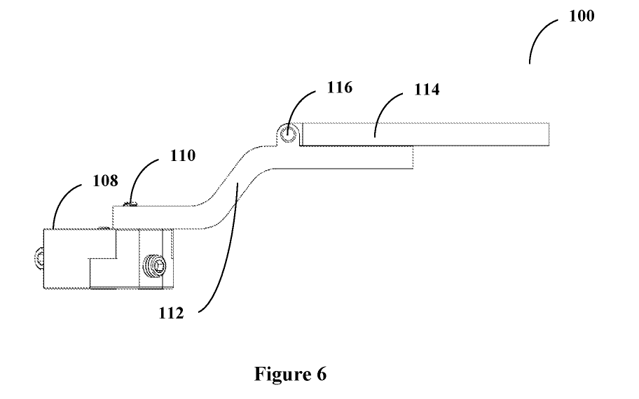

Referring to the FIG. 4; FIG. 5; and FIG. 6 are diagrams illustrating perspective; upper and side views correspondingly of a strapless bracket system comprising a bolt down bracket and an universal clamp, in accordance with one embodiment of the present invention.

In accordance with an alternative embodiment of the present invention, the strapless bracket system (100) for securely holding at least one panel on a hood stand is provided. The at least one panel may be selected from a group comprising but not limited to automotive doors, hoods, lift gates, trunks, and side mount panels. The strapless bracket system (100) may comprises of the bolt down bracket (112) and the universal clamp (100), wherein the bolt down bracket (112) may be coupled with the universal clamp (100) using the quick release pin (110). The bolt down bracket (112) may be adapted for mounting and adjusting the at least one panel on the hood stand using the mounting location on the at least one panel. The universal clamp (100) may be adapted for enabling the strapless bracket (102) and the bolt down bracket (112) to be mounted on the hood stand, wherein the bolt down bracket (112) may be coupled with the universal clamp (100) using the quick release pin (110). The bolt down bracket (112) may be CNC machined from a solid block of aluminum.

In accordance with one embodiment of the present invention, the bolt down bracket (112) may further comprises of an adjustable flap (114) coupled with the bolt down bracket (112) through a hinge (116). The adjustable flap (114) may be coupled with the bolt down bracket (112) and 180 degree adjustable through the hinge (116) for side mounting of the at least one panel with help of at least two mounting holes (118).

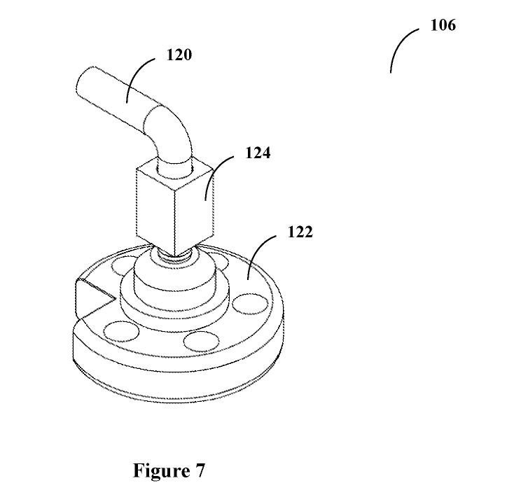

Referring to the FIG. 7 is a diagram illustrating perspective view of a cinch, in accordance with one embodiment of the present invention.

In accordance with one embodiment of the present invention, the cinch (106) may further comprises of the L shape hook (120) for pulling the at least one panel securely to the neoprene padded foot (104) coupled with the strapless bracket (102). The cinch (106) may further comprises of the tension knob (122) for adjusting hold down pressure on the at least one panel. The tension knob (122) may be connected with the L shape hook (120) using the rectangular support (124).

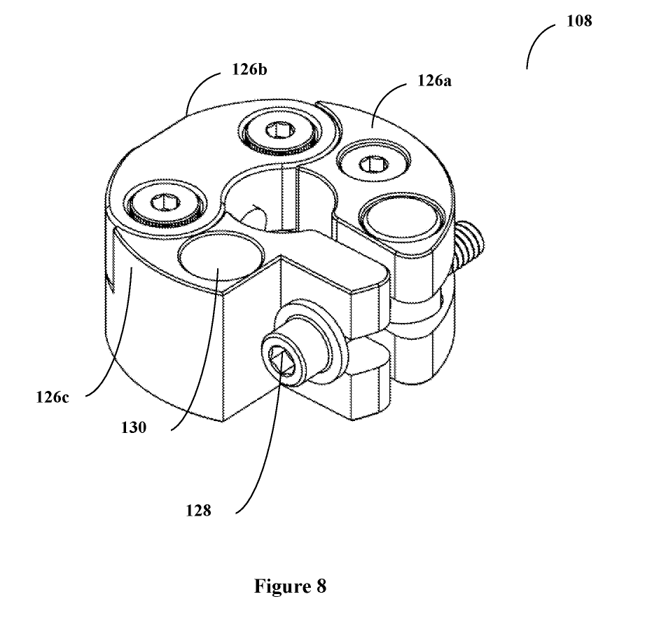

Referring to the FIG. 8 is a diagram illustrating perspective view of a universal clamp, in accordance with one embodiment of the present invention.

In accordance with one embodiment of the present invention, the universal clamp (108) may allow the strapless bracket (102) and the bolt down bracket (112) to be mounted in any position desired on the hood stand. The universal clamp (108) may be designed in such a way to mount quickly to any hood stand of round or square tubing without slipping or moving. The universal clamp (108) may further comprise of at least three sub clamp (126a; 126b; and 126c). The sub clamp 126a may be rotatable connected with the sub clamp 126b. The sub clamp 126b may be rotatable connected with the sub clamp 126c. The sub clamp 126c may be releasable connected with 126a using a connecting pin (128). The universal clamp (108) may further comprises of an opening for quick release pin (130) enabling the strapless bracket (102) and the bolt down bracket (112) to be coupled with the universal clamp (100) using the quick release pin (110). The universal clamp (108) may further comprises of more than one opening for quick release pin (130) enabling the strapless bracket (102) and the bolt down bracket (112) to be coupled with the universal clamp (100) using the quick release pin (110). The universal clamp (108) may be available in 3 sizes ¾″, 1″, and 1¼″. The universal clamp (108) may be CNC machined from a solid block of aluminum, and thread post may be stainless steel.

In accordance with one embodiment of the present invention, the cap bracket mount adapted for enabling the strapless bracket (102) and the bolt down bracket (112) to be mounted on top of the hood stand. The cap bracket mount may allow the strapless bracket (102) and the bolt down bracket (112) to be mounted on top of a hood stand post of the hood stand with a ¾″ round tubing. The cap bracket mount may be CNC machined from a solid tube of aluminum and may be held in position with allen set screw.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope of the present invention.

What is claimed is:

1. A strapless bracket system (100) for securely holding at least one panel on a hood stand; wherein said strapless bracket system (100) comprises of:
a. a strapless bracket (102) adapted for pulling said at least one panel securely to a neoprene padded foot (104) coupled with said strapless bracket (102);
b. a bolt down bracket (112) adapted for mounting and adjusting said at least one panel on said hood stand;
c. an universal clamp (108) adapted for enabling said strapless bracket (102) and said bolt down bracket (112) to be mounted on said hood stand; and
d. a cap bracket mount adapted for enabling said strapless bracket (102) and said bolt down bracket (112) to be mounted on top of said hood stand.

2. The strapless bracket system (100) as claimed in claim 1, wherein said strapless bracket system (100) is manufactured from a material selected from a group comprising aluminum, stainless steel, and rubber.

3. The strapless bracket system (100) as claimed in claim 1, wherein said at least one panel is selected from a group comprising automotive doors, hoods, lift gates, trunks, and side mount panels.

4. The strapless bracket system (100) as claimed in claim 1, wherein said universal clamp (108) further comprises of at least three sub clamp 126a rotatable connected with 126b; 126b rotatable connected with 126c; 126c releasable connected with 126a using a connecting pin (128); and an opening for quick release pin (130) enabling said strapless bracket (102) and said bolt down bracket (112) to be mounted on said hood stand.

5. A strapless bracket system (100) for securely holding at least one panel on a hood stand; wherein said strapless bracket system (100) comprises of a strapless bracket (102) adapted for pulling said at least one panel securely to a neoprene padded foot (104) coupled with said strapless bracket (102) with help of a cinch (106); and an universal clamp (100) adapted for enabling said strapless bracket (102) and said bolt down bracket (112) to be mounted on said hood stand, wherein said strapless bracket (102) is coupled with said universal clamp (100) using a quick release pin (110).

6. The strapless bracket system (100) as claimed in claim 5, wherein said strapless bracket (102) pulls said at least one panel securely to said neoprene padded foot (104) coupled with said strapless bracket (102) with help of said cinch (106) using an opening of ¼″ or larger in said at least one panel.

7. The strapless bracket system (100) as claimed in claim 5, wherein said cinch (106) further comprises of a L shape hook (120) for pulling said at least one panel securely to said neoprene padded foot (104) coupled with said strapless bracket (102), a tension knob (122) for adjusting hold down pressure on said at least one panel, connected with the L shape hook (120) using a rectangular support (124).

8. A strapless bracket system (100) for securely holding at least one panel on a hood stand; wherein said strapless bracket system (100) comprises of a bolt down bracket (112) adapted for mounting and adjusting said at least one panel on said hood stand using a mounting location on said at least one panel; and an universal clamp (100) adapted for enabling said strapless bracket (102) and said bolt down bracket (112) to be mounted on said hood stand, wherein said bolt down bracket (112) is coupled with said universal clamp (100) using a quick release pin (110).

9. The strapless bracket system (100) as claimed in claim 8, wherein said bolt down bracket (112) further comprises of an adjustable flap (114) coupled with said bolt down bracket (112) through a hinge (116).

10. The strapless bracket system (100) as claimed in claim 9, wherein said adjustable flap (114) coupled with said bolt down bracket (112) is 180 degree adjustable through said hinge (116) for side mounting of said at least one panel with help of at least two mounting holes (118).
